(19) United States
(12) Patent Application Publication
(10) Pub. No.: US 2010/0114401 A1
(43) Pub. Date: May 6, 2010

(54) Method and Device of Predicting the Level of Customer Amount, and Method and System of Controlling Temperature of Aircondiction by Using the Same

(75) Inventors: Wen-Hsiang Tseng, Jiadong Township (TW); Cheng-Ting Lin, Jhongli City (TW)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: INDUSTRIAL TECHNOLOGY RESEARCH INSTITUTE, Hsinchu (TW)

(21) Appl. No.: 12/578,985

(22) Filed: Oct. 14, 2009

(30) Foreign Application Priority Data
Nov. 6, 2008 (TW) 97142956
Sep. 8, 2009 (TW) 98130289

(51) Int. Cl. G05D 23/19; G06Q 10/00; G06N 5/02; G06F 17/30; G06F 17/40

(52) U.S. Cl. 700/300; 705/10; 706/52

(57) ABSTRACT

A method of predicting the level of customer amount is provided. The method at least comprises the steps of: (a) a counter counting person-time within a time period; (b) a processor checking whether a referenced customer amount of the time period is stored in a database if being at the beginning of the time period; and (c) the processor estimating the level of customer amount according to the referenced customer amount of the time period if the referenced customer amount of the time period is stored in a database.

This application claims the benefits of Taiwan applications Serial No. 97142956, filed Nov. 6, 2008 and Ser. No. 98/130,289, filed Sep. 8, 2009, the subject matter of which is incorporated herein by reference.

### BACKGROUND OF THE INVENTION

1. Field of the Invention

The invention relates in general to a method and a device of predicting amount, and more particularly to a method and a device of predicting the level of customer amount and a method and a system of controlling aircondictioning temperature by using the same.

2. Description of the Related Art

Despite convenient shop is small, its power consumption index is even higher than similar business such as department store and super market. As power consumption has become a universal value, how to design an effective and suitable power-saving system for convenient shop has become an important issue of research.

Convenient shop is a place for serving customers, and the power-saving policies should not affect the business. In Japan Patent Publication No. JP2006178886, “Store Management System”, a structure integrating POS and shop management is disclosed. The structure provides remote network link and power-saving policy for controlling airconditioning and illuminating facilities. However, the above system is too costive and takes a long period to recover the cost. Also, the structure is too complicated and makes it difficult to bring down the associated hardware cost and software design cost. As a result, the practicality is poor.

In United State Patent No. US2002163431, “In-Store Equipment Remote Monitoring System”, a monitoring system is disclosed. The monitoring system collects the parameters such as the indoor/outdoor illumination, the refrigerator temperature, the outdoor temperature, and the shut/open frequency of the automatic door. The system predicts tomorrow's weather, illumination according to these parameters, and further provides suggested indoor illumination and indoor airconditioning temperature as a basis for the user to adjust the facilities. However, the system is too costive to construct, the structure is too complicated and makes it difficult to bring down the associated hardware cost and software design cost. Particularly, the system does not automatically adjust the operation of the facilities, and it is not practical for the shop keepers to manually adjust the facilities when the business is busy and the environmental factors are changing frequently. Therefore, it is necessary to provide a power-saving policy which is automatic and effective.

### SUMMARY OF THE INVENTION

The invention is directed to a method and a device of predicting the level of customer amount. The method is capable of predicting the level of customer amount of a future time period according to statistical data.

According to a first aspect of the present invention, a method of predicting the level of customer amount is provided. The method at least comprises the following steps of (a) a counter counting person-time within a time period; (b) a processor checking whether a referenced customer amount of the time period being stored in a database if being at the beginning of the time period; and (c) the processor estimating the level of customer amount according to the referenced customer amount of the time period if the referenced customer amount of the time period is stored in a database.

According to a second aspect of the present invention, a method of controlling aircondictioning temperature is provided. The method comprises the following steps of (a) a measuring unit measuring the outdoor temperature of a time period; (b) a processor predicting the level of customer amount; and (c) the processor setting airconditioning temperature according to the outdoor temperature of the time period and the level of customer amount. Step (b) comprises the sub-steps of (b1) the counter counting the person-time within a time period; (b2) the processor checking whether a referenced customer amount of the time period is stored in a database if being at the beginning of the time period; and (b3) the processor estimating the level of customer amount according to the referenced customer amount if the referenced customer amount of the time period is stored in a database.

According to a third aspect of the present invention, a device of predicting the level of customer amount is provided. The device at least comprises a counter, for counting the person-time within a time period; a database, for storing a plurality of person-time and referenced customer amount; and a processor for checking whether a referenced customer amount of the time period is stored in a database if being at the beginning of the time period, and the processor estimating the level of customer amount according to the referenced customer amount if the referenced customer amount of the time period is stored in the database.

According to a fourth aspect of the present invention, a system of controlling aircondicting temperature is provided. The system at least comprises a measuring unit for measuring the outdoor temperature of a time period; a counter, for counting the person-time within a time period; a database, for storing a plurality of person-time and referenced customer amount; and a processor for checking whether a referenced customer amount of the time period is stored in a database if being at the beginning of the time period, and the processor estimating the level of customer amount according to the referenced customer amount if the referenced customer amount of the time period is stored in the database. The processor sets the aircondicting temperature according to the outdoor temperature of the time period and the level of customer amount.

The invention will become apparent from the following detailed description of the preferred but non-limiting embodiments. The following description is made with reference to the accompanying drawings.

### BRIEF DESCRIPTION OF THE DRAWINGS

FIG. 1 shows a block diagram of a device of predicting the level of customer amount according to a first embodiment of the invention;

FIG. 2 shows a flowchart of a method of predicting the level of customer amount according to a first embodiment of the invention;

FIG. 3 shows a block diagram of a system of controlling aircondictioning temperature according to a second embodiment of the invention; and

FIG. 4 shows a flowchart of a method of controlling aircondictioning temperature according to a second embodiment of the invention; and

FIG. 5 shows the relationship between outdoor temperature and aircondition setting temperature.

### DETAILED DESCRIPTION OF THE INVENTION

The invention provides a control concept. For some business places, management has much to do with customer amount. After estimating and grading the customer amount into useful statistical data, the invention provides a method of predicting the level of customer amount. The method capable of predicting the level of customer amount of a future time period according to statistical data has a wide range of application. For example, the predicting method and device is applicable to the method and a system of controlling aircondictioning temperature as indicated in a second embodiment of the invention but is not limited thereto.

### FIRST EMBODIMENT

A method and a device of predicting the level of customer amount are provided in the present embodiment. The device of predicting the level of customer amount at least includes a counter, a database and a processor. The method of predicting the level of customer amount according to the present embodiment of the invention at least comprises the following steps of (a) a counter counting person-time within a time period; (b) a processor checking whether a referenced customer amount of the current time period is stored in a database if being at the beginning of the time period; and (c) the processor estimating the level of customer amount of the current time period according to the referenced customer amount if the referenced customer amount of the time period is stored in the database.

Let time be defined as a plurality of time cycles W, and each time cycle W has N time periods, namely, T1, T2, T3 . . . Tn . . . TN. For example, let one week be one time cycle, and every 10 minutes be a time period. As one week has 10080 minutes, which equals to 1008 units of 10 minutes, each time cycle has 1008 time periods denoted by T1, T2, T3 . . . T1008 sequentially. For example, time period T2 denotes 0:10˜0:20 every Sunday. The method of the present embodiment of the invention can be used to predict the level of customer amount for convenient shops, theaters, department stores, super markets, public toilets, and so on. The method is exemplified by the application in a convenient shop, and detailed steps of the method are disclosed below.

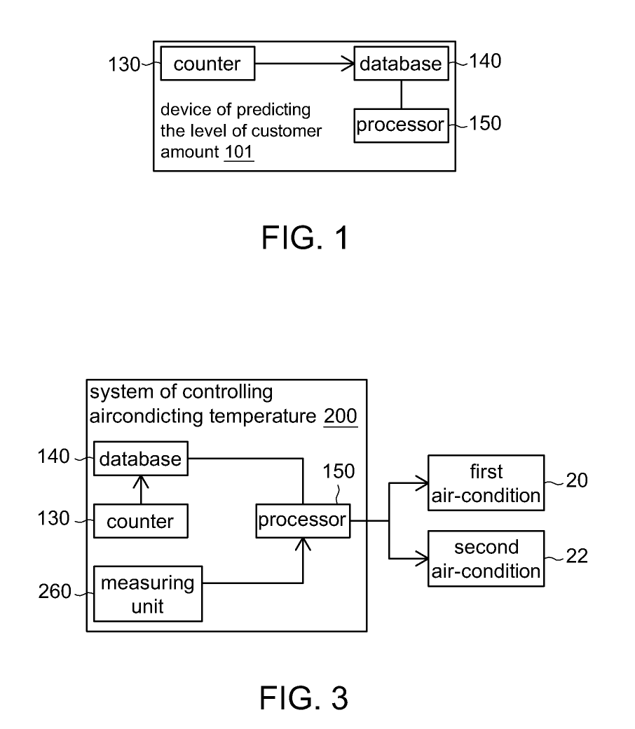

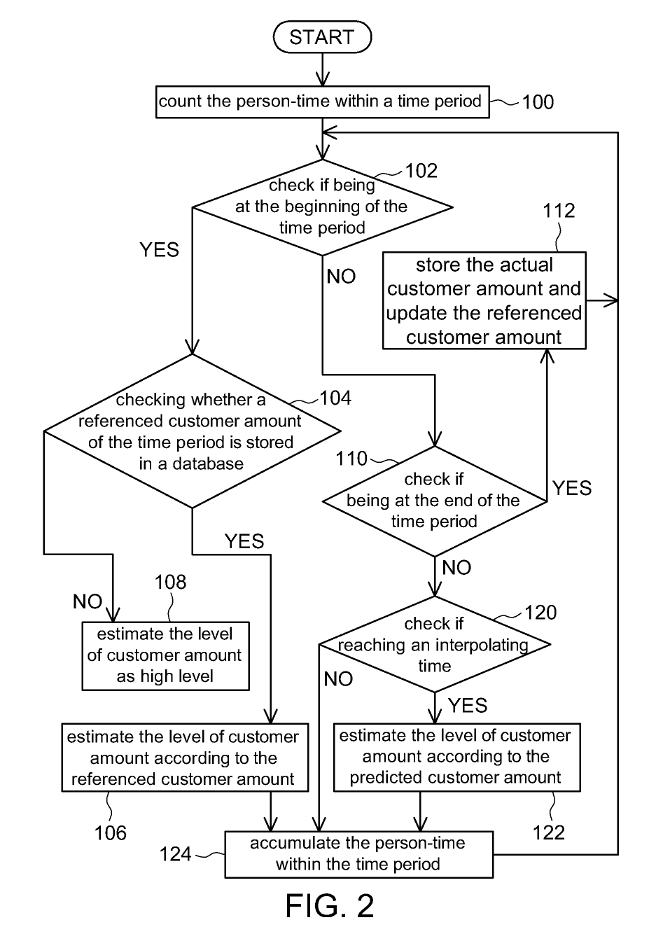

FIG. 1 shows a block diagram of a device of predicting the level of customer amount according to a first embodiment of the invention. FIG. 2 shows a flowchart of a method of predicting the level of customer amount according to a first embodiment of the invention. Referring to FIG. 1 the device of predicting the level of customer amount includes a counter 130, a database 140 and a processor 150. Referring to both FIG. 1 and FIG. 2, the method begins at step 100, in which the person-time within a time period Tn is counted by the counter 130. In the present embodiment of the invention, the customer amount is estimated according to the person-time. For example, a sensor is disposed in the automatic door of a convenient shop. When the sensor senses a customer entering the sensing range, the count is added by 1. The sensing times does not exactly equal the number of customers. However, the sensing times can be used to estimate the customer amount of the time period Tn.

Next, the method proceeds to step 102, whether being at the beginning of the time period is determined by the processor 150. As indicated in step 104, the processor 150 checks whether the database contains a referenced customer amount Rn of the time period Tn if being at the beginning of the time period. After the system has operated for a period of time, the database will store many items of data, including the referenced customer amount of many past time periods of one or multiple time cycles. The way of obtaining the data is indicated in steps 110 and 112.

Then, the method proceeds to step 106, the level of customer amount of the time period Tn is estimated by the processor 150 according to referenced customer amount Rn if the database 140 contains the referenced customer amounts R1, R2, R3 . . . RN of the time periods T1, T2, T3 . . . TN. The customer amount is preferably graded according to the proportion of the referenced customer amount Rn to the maximum customer amount M. The maximum customer amount M is defined as below. The processor 150 takes the average value of the first n largest items of referenced customer amount of the N items of referenced customer amount as a maximum customer amount M, wherein both n and N are positive integers, n=N/20. In a preferred embodiment, the level of customer amount of the time period Tn is estimated as high level if the referenced customer amount Rn is larger than 70% of the maximum customer amount M (that is, Rn/M>0.7). The level of customer amount of the time period Tn is estimated as middle level if the referenced customer amount Rn ranges 35%˜70% of the maximum customer amount (that is, 0.35<Rn/M<0.7). The level of customer amount of the time period Tn is estimated as low level if the referenced customer amount Rn is smaller than 35% of the maximum customer amount (that is, Rn/M<0.35).

According to the definition of the maximum customer amount M of the present embodiment of the invention, n is set to be approximately 1/20 of N (that is, 5% N). However, anyone who is skilled in the art of the invention will understand that the maximum customer amount being set as the average value of the first 5% or 20% of referenced customer amount is one of possible parameters, but the invention is not limited thereto. Likewise, the grading of the customer amount is not limited thereto. Anyone who is skilled in the art of the invention will understand that there are various ways of grading the customer amount. For example, the customer amount can be graded into two levels, namely, high level and low level, or graded into five or more than five levels. The number of levels of grading the customer amount is adjusted to fit different fields of application. If the customer amount is graded into three levels as indicated in the present embodiment of the invention, the critical values marking different levels are not limited. In the present embodiment of the invention, 35% and 70% are used as the critical values for the maximum customer amount, but the invention is not limited thereto. For example, 25% and 75% can also be used as critical values.

In steps 102-106, the level of customer amount of the current time period is predicted according to historical data stored in the database 140. That is, the customer amount of the time period in the future is predicted according to the referenced customer amount of the same time period in past time cycles. As customer amount is highly correlated with time cycle, the predicted result will be more accurate.

As indicated in step 108, the level of customer amount of the time period is set at high level if the database 140 does not contain the referenced customer amount.

In step 110, the processor 150 determines if being the end of the time period. The person-time of the time period Tn is accumulated until the end of the time period by the counter 130 as an actual customer amount Xn(Wᵢ). Afterwards, the method proceeds to step 122, the actual customer amount Xn of the time period Tn is stored in the database 140, and the time period of the referenced customer amount Rn′ is updated by the processor 150. Preferably, the average value of the actual customer amount Xn(Wᵢ) of the time period Tn of the current time cycle and the referenced customer amount Rn(Wᵢ₋₁) of the database is served as the referenced customer amount Rn′ of the time period Tn of the next time cycle, wherein the referenced customer amount Rn′=[Rn(Wᵢ₋₁)+Xn(Wᵢ)]/2. In a preferred embodiment, the referenced customer amount is defined and updated as below:

Rn′=(Rn(Wᵢ₋₁)+Xn(Wᵢ))/2;

Rn(Wᵢ₋₁): a referenced customer amount R of the time period Tn stored in the database;

Xn(Wᵢ): an actual customer amount of the time period Tn of a previous time cycle;

Rn′: an updated referenced customer amount of the time period Tn.

For example, the referenced customer amount of 13:00˜13:10 on Tuesday stored in the database is 60, and the actual customer amount of 13:00˜13:10 on Tuesday is 80, so the average value of the referenced customer amount and the actual customer amount is 70, that is, (60+80)/2=70, and is used as the referenced customer amount of 13:00˜13:10 next Tuesday.

In step 120, whether the estimating time is reached is determined by the processor 150 if neither being the beginning nor the end of the time period. Next, the method proceeds to step 122, the level of customer amount of the current time period is predicted by the processor 150 according to the currently accumulated actual person-time if the estimating time of the time period is reached. Preferably, the estimating time is approximately a half of the time period. For example, if a time period is 10 minutes, then the estimating time is 5 minutes. The method of predicting the level of customer amount of the current time period comprises the following steps of: (a) the processor 150 calculating a predicted customer amount Pn according to the currently accumulated actual person-time by using the estimation method; and (b) the processor 150 calculating the level of customer amount of the current time period according to the proportion of the predicted customer amount to the maximum customer amount M. Let the time period T2 (0:10˜0:20 on Sunday) be taken for example. Suppose the actual person-time is 5 at 0:15, then the average person-time per minute is 1. Suppose the person-time for the remaining 5 minutes follows the same trend, then the accumulated person-time at the end of the time period is estimated to be 10 by the estimation method and is used as a predicted customer amount. The estimation method can be interpolation or extrapolation. After the predicted customer amount Pn is obtained by the estimation method, the level of customer amount of the current time period is estimated according to the proportion of the predicted customer amount Pn to the maximum customer amount M. The method of calculating the maximum customer amount M is the same as that indicated in step 106. In a preferred embodiment, the level of customer amount of the time period Tn is estimated as high level if the predicted customer amount Pn is larger than 70% of the maximum customer amount M (that is, Pn/M>0.7); the level of customer amount of the time period Tn is estimated as middle level if the predicted customer amount Pn ranges 35%˜70% of the maximum customer amount (that is, 0.35<Pn/M<0.7); and the level of customer amount of the time period Tn is estimated as low level if the predicted customer amount Pn is smaller than 35% of the maximum customer amount (that is, Pn/M<0.35).

As there may be discrepancy between actual customer amount and referenced customer amount, in step 120-122, the next level of customer amount of the current time period is predicted according to the real-time accumulated data of the person-time within the estimating time of the current time period. That is, representative person-time data is accumulated from the beginning of the time period to the estimating time, and the level of customer amount of the current time period is more accurately predicted if the customer amount of the second half of the current time period is estimated according to the actual customer amount of the first half of the current time period.

Lastly, the method proceeds to step 124, regardless being at the beginning, the middle or the end of the time period, the person-time of the time period continues to be accumulated after the level of customer amount is graded. At the end of the time period, the accumulated actual customer amount is stored in the database 140 by the counter 130 and the referenced customer amount is updated by the processor. As the customer amount is highly correlated with the time cycle, the accuracy in the prediction of the level of customer amount will increase if the data is updated periodically.

### SECOND EMBODIMENT

The present embodiment of the invention provides a method of controlling aircondictioning temperature by using the method of predicting the level of customer amount. The method of controlling aircondictioning temperature adjusts aircondition setting temperature according to two control factors, namely, outdoor temperature and level of customer amount.

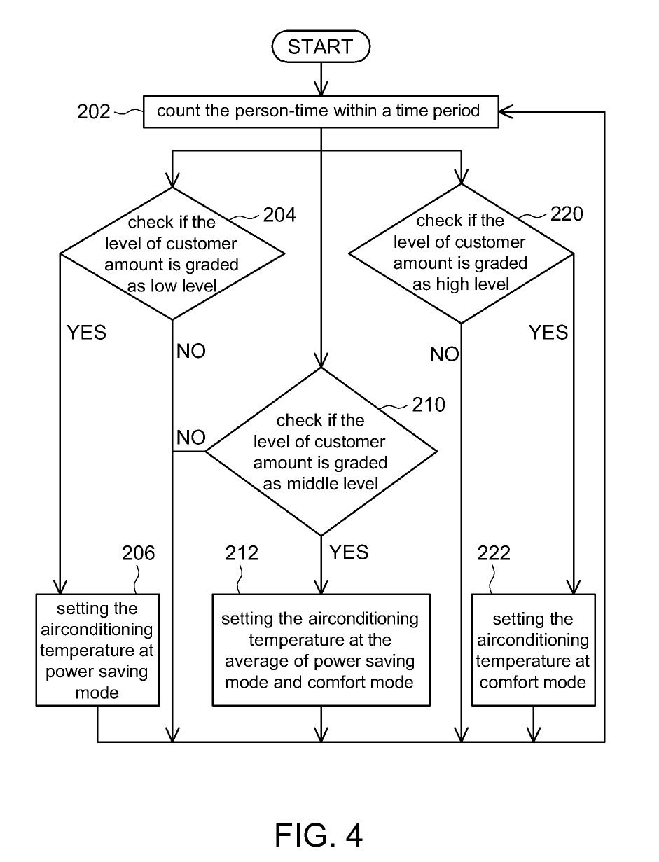

Referring to FIG. 3-4, FIG. 3 shows a block diagram of a system of controlling aircondictioning temperature according to a second embodiment of the invention, and FIG. 4 shows a flowchart of a method of controlling aircondictioning temperature according to a second embodiment of the invention is shown. The system 200 of controlling airconditioning temperature according to present embodiment includes a counter 130, a database 140, a processor 150 and a measuring unit 260. The method of controlling aircondictioning temperature of the present embodiment at least includes the following steps. Firstly, the method begins at step 202, the outdoor temperature of a time period is measured by the measuring unit 260. Next, the level of customer amount is predicted by the processor 150, and the predicting method is disclosed in the first embodiment and not repeated here. Lastly, the airconditioning temperature is set by the processor according to the outdoor temperature of the time period and the level of customer amount.

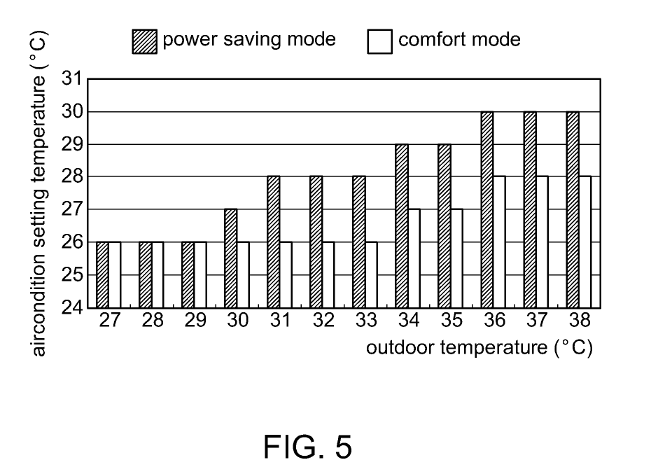

FIG. 5 shows the relationship between outdoor temperature and aircondition setting temperature. In a preferred embodiment, the processor 150 applies the outdoor temperature measured by the measuring unit 260 to a corresponding relationship so as to obtain two corresponding airconditioning temperatures. Two patterns can be derived from the two bar charts in FIG. 3: the upper one is for power-saving mode, and the lower one is for comfort mode. When the outdoor temperature is 37° C., the airconditioning temperature is set at 28° C. and 30° C. for comfort mode and power-saving mode respectively.

In step 204, whether the level of customer amount is at low level is determined by the processor 150. If the level of customer amount is not at low level, the outdoor temperature is re-measured and the level of customer amount is determined again by the processor 150. If the level of customer amount is at low level, then the method proceeds to step 206, the airconditioning temperature is set by the processor 150 at the higher of the two airconditioning temperatures. For example, if the outdoor temperature of the time period is 37° C. and the level of customer amount is low, the processor 150 will set the aircondition at power-saving mode, that is, the airconditioning temperature is set at 30° C., to reduce the required power consumption of aircondition and cut down power consumption and power bill.

In step 220, whether the level of customer amount is at high level is determined by t he processor 150. If the level of customer amount is not at high level, the outdoor temperature is re-measured by the measuring unit 260 and the level of customer amount is determined again by the processor 150. If the level of customer amount is at high level, the method proceeds to step 222, the processor 150 will set the airconditioning temperature at the lower of the two airconditioning temperatures. For example, if the outdoor temperature of the time period is 37° C. and the level of customer amount is high, the aircondition is set at comfort mode, that is, the airconditioning temperature is set at 28° C. Also, higher level of customer amount implies more customers in the shop and the automatic door is shut and opened more frequently (higher outflow of cool air means higher inflow of hot air). When there are a large number of customers, the automatic door will be shut and opened more frequently and there will be a large influx of hot air. Under such circumstances, the indoor temperature cannot be reduced to a pre-set temperature within a short period of time. Therefore, if the customer amount of the next time period can be predicted and the indoor temperature is adjusted at the beginning of or prior to the time period with high customer amount, the level of comfort within the shop can be maintained without consuming a large amount of power.

In step 210, whether the level of customer amount is at high level is determined by the processor 150. If the level of customer amount is not at high level, then the outdoor temperature is re-measured by the measuring unit 260 and the level of customer amount is determined again by the processor 150. If the level of customer amount at middle level, then the method proceeds to step 212, the processor 150 will set the airconditioning temperature at the average value of two airconditioning temperatures. For example, if the outdoor temperature of the time period is 37° C. and the level of customer amount is determined as middle level, the processor 150 will set the aircondition at a temperature between comfort mode and power-saving mode, that is, the airconditioning temperature is set at (28+30)/2=29° C.

The hardware facility required by the above controlling method is simple and the installation cost is low. In terms of the control of airconditioning temperature, the controlling method only needs a counter (e.g., a sensor) to count the person-time, a measuring unit (e.g., an outdoor thermometer), a processor and a database. The processor which can be implemented by a personal computer or an embedded system receives data from the counter and the measuring unit, applies data processing to the received data and then outputs a control command to the airconditioning facility (i.e., 20 and 22 in FIG. 3).

The method of predicting the level of customer amount has a wide range of application and is not limited to the exemplifications of the invention. Let convenient shop be taken for example. The results of predicting the level of customer amount can be used in the control or management of other facilities in the shop such as the method of controlling refrigerator temperature, the method of controlling illumination system, and the timing of providing seasonal facility. Also, the results of predicting the level of customer amount can be used in shop-wide control of power consumption or in logistic management between the shop and the suppliers. The above methods of control and management add efficiency to the management of the shop.

According to the device and method of predicting the level of customer amount and the device and method of controlling aircondictioning temperature by using the same disclosed in the above embodiments of the invention, the level of customer amount of a future time period is predicted according to statistical data, and the result of prediction can further be modified according to real-time customer amount. The method of predicting the level of customer amount can further be used in the method of controlling aircondictioning temperature to increase the aircondition setting temperature during the time period with low level of customer amount, such that the power consumption of airconditioning facility is reduced and power bill is cut down. Moreover, the hardware facility required by the above controlling method is simple and the installation cost is low.

While the invention has been described by way of example and in terms of a preferred embodiment, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A method of predicting the level of customer amount, the method comprising:
a counter counting the person-time within a time period;
a processor checking whether a referenced customer amount of the time period is stored in a database if being at the beginning of the time period; and
the processor estimating the level of customer amount according to the referenced customer amount if the referenced customer amount of the time period is stored in the database.

2. The method according to claim 1, wherein a time cycle comprises N time periods, when the database at least contains N items of referenced customer amount of the time cycle, the processor taking the average value of the first n largest items of referenced customer amount of the N items of referenced customer amount as a maximum customer amount, both n and N are a positive integer, and the customer amount is graded by the processor according to the proportion of the referenced customer amount to the maximum customer amount.

3. The method according to claim 2 further comprising:
the processor estimating the level of customer amount as high level if the referenced customer amount approximately is larger than 70% of the maximum customer amount;
the processor estimating the level of customer amount as middle level if the referenced customer amount approximately ranges 35%˜70% of the maximum customer amount;
the processor estimating the level of customer amount as low level if the referenced customer amount approximately is smaller than 35% of the maximum customer amount.

4. The method according to claim 1 further comprising:
the processor setting the level of customer amount as high level if the referenced customer amount is not stored in the database.

5. The method according to claim 1 further comprising:
the processor predicting the level of customer amount according to the currently accumulated person-time if counting goes on for an estimating time.

6. The method according to claim 5, wherein the estimating time is approximately half of the time period.

7. The method according to claim 5, wherein the method of predicting the level of customer amount comprises:
the processor obtaining a predicted customer amount according to the currently accumulated person-time by an the estimation method; and
the processor calculating the level of customer amount according to the proportion of the predicted customer amount to the maximum customer amount.

8. The method according to claim 1 further comprising:
the counter accumulating the person-time within the time period as an actual customer amount if being at the end of the time period;
the counter storing the actual customer amount of the time period in the database and the processor updating the referenced customer amount of the time period therein.

9. The method according to claim 1, wherein the method of updating the referenced customer amount of the time period comprises:
the processor using the average value of the referenced customer amount and the actual customer amount of the time period as a referenced customer amount of the time period of the next time cycle.

10. A method of controlling aircondictioning temperature, the method comprising:
a measuring unit measuring the outdoor temperature of a time period;
a processor predicting the level of customer amount, comprising:
a counter counting the person-time within a time period;
the processor checking whether a referenced customer amount of the time period is stored in a database if being at the beginning of the time period; and
the processor estimating the level of customer amount according to the referenced customer amount if the referenced customer amount of the time period is stored in the database; and
the processor setting the airconditioning temperature according to the outdoor temperature of the time period and level of customer amount.

11. The method according to claim 10 further comprising:
the processor applying the outdoor temperature measured by the measuring unit to a corresponding relationship so as to obtain two set values of airconditioning temperature.

12. The method according to claim 11, wherein the step of setting airconditioning temperature comprises:
the processor setting the airconditioning temperature at the higher of the two set values of airconditioning temperature if the level of customer amount is at low level.

13. The method according to claim 11, wherein airconditioning temperature is set at the lower of the two set values of airconditioning temperature if the level of customer amount is at high level.

14. The method according to claim 11, wherein airconditioning temperature is set at the average value of the two set values of airconditioning temperature if the level of customer amount is at middle level.

15. The method according to claim 10, wherein a time cycle comprises N time periods, the database contains at least N items of referenced customer amount of the N time periods, the processor taking the average value of the first n largest items of referenced customer amount of the N items of referenced customer amount as a maximum customer amount, both n and N are a positive integer, and the customer amount is graded by the processor according to the proportion of the referenced customer amount to the maximum customer amount.

16. The method according to claim 15, wherein the step of predicting the level of customer amount further comprises:
the processor estimating the level of customer amount as high level if the referenced customer amount approximately is larger than 70% of the maximum customer amount.
the processor estimating the level of customer amount as middle level if the referenced customer amount approximately ranges 35%˜70% of the maximum customer amount;
the processor estimating the level of customer amount as low level if the referenced customer amount approximately is smaller than 35% of the maximum customer amount.

17. The method according to claim 10 further comprising:
the processor setting the level of customer amount as high level if the referenced customer amount is not stored in the database.

18. The method according to claim 10 further comprising:
the processor predicting the level of customer amount according to the currently accumulated person-time if counting goes on for an estimating time.

19. The method according to claim 18, wherein the estimating time is approximately a half of the time period.

20. The method according to claim 18, wherein the method of predicting the level of customer amount comprises:
the processor obtaining a predicted customer amount according to the currently accumulated person-time by an estimation method; and
the processor calculating the level of customer amount according to the proportion of the predicted customer amount to the maximum customer amount.

21. The method according to claim 18 further comprising:
the counter accumulating the person-time within the time period as an actual customer amount if being at the end of the time period;
the counter storing the actual customer amount of the time period in the database and the processor updating the referenced customer amount of the time period therein.

22. The method according to claim 18, wherein the method of updating the referenced customer amount of the time period comprises:
the processor using the average value of the referenced customer amount and the actual customer amount of the time period as a referenced customer amount of the time period of the next time cycle.

23. A device of predicting the level of customer amount, comprising:
a counter, for counting the person-time within a time period;
a database, for storing a plurality of person-time and referenced customer amount; and
a processor for checking whether a referenced customer amount of the time period is stored in a database if being at the beginning of the time period, and the processor estimating the level of customer amount according to the referenced customer amount if the referenced customer amount of the time period is stored in the database.

24. A system of controlling aircondicting temperature, the system comprising:
a measuring unit for measuring the outdoor temperature of a time period;
a counter, for counting the person-time within a time period;
a database, for storing a plurality of person-time and referenced customer amount; and
a processor for checking whether a referenced customer amount of the time period is stored in a database if being at the beginning of the time period, and the processor estimating the level of customer amount according to the referenced customer amount if the referenced customer amount of the time period is stored in the database;
wherein the processor setting the aircondicting temperature according to the outdoor temperature of the time period and the level of customer amount.
